(19) United States
(12) Patent Application Publication
(10) Pub. No.: US 2024/0326002 A1
(43) Pub. Date: Oct. 3, 2024

(54) A SYSTEM FOR GENERATING PHOSPHINE GAS

(71) Applicant: UPL LIMITED, Mumbai, Maharashtra (IN)

(72) Inventors: Rajnikant SHROFF, Mumbai, Maharashtra (IN); Pushpaksen P ASHER, Vapi, Gujarat (IN)

(21) Appl. No.: 18/578,939

(22) PCT Filed: Jul. 15, 2022
(86) PCT No.: PCT/IB2022/056520

§ 371 Date: Jan. 12, 2024

(30) Foreign Application Priority Data
Jul. 15, 2021 (IN) 202121031814

(51) Int. Cl. B01J 8/22; B01J 8/18; B01J 8/26; C01B 6/00

(52) U.S. Cl. CPC B01J 8/22; B01J 8/1809; B01J 8/1836; B01J 8/26; C01B 6/00; B01J 2208/00061; B01J 2208/00539; B01J 2208/00548

(57) ABSTRACT

A system for generating phosphine gas by mixing a metal phosphide and water upon agitation and dilution with air, and a method of generating phosphine gas using said system.

### FIELD OF THE INVENTION

The present invention broadly relates to a system for generating phosphine gas. Phosphine gas is generated by mixing a metal phosphide and water upon agitation and dilution with air and used for fumigation purposes.

### BACKGROUND OF THE INVENTION

Fumigation of stored agricultural commodities such as grains with phosphine gas is the preferred method for preventing insect damage. Typically, fumigation is achieved by introducing pellets or tablets containing metal phosphide directly into the grain to be fumigated. The metal phosphide reacts with the ambient moisture in the air and grain, resulting in the generation of a phosphine gas and other inert gases. Forced air circulation devices are often used to assist in the distribution of the phosphine gas throughout a storage structure, such as a grain silo.

A common fumigation problem encountered with prior practices is the inability to achieve a uniform concentration of phosphine gas within the storage structure quickly. It is known that for the most effective insect control, it is necessary to maintain the desired concentrations of phosphine for sufficiently long periods. However, with prior methods, the release of phosphine gas is slow and takes three to seven days or more depending on the ambient conditions.

Batch processes for the generation of phosphine gas have been proposed in the past. Such batch processes include a batch reactor for the hydrolysis of metal phosphides to obtain phosphine gas, the latter being stored in closed cylinders. Such containers can then be used on-site to deliver phosphine gas at a specific concentration throughout a selected period of fumigation. A significant drawback of this technique is that one must store the phosphine gas in pressure vessels with subsequent delivery of the vessels to the storage structure. This results in a need for expensive cylinders and poses handling hazards. Also, the phosphine gas must be transported to the fumigation site.

A very common fumigation problem encountered with prior practices is the use of CO₂, N₂, argon, and other similar gases which aim to dilute the phosphine gas concentration and to maintain low levels of phosphine gas until the phosphine gas reaches the storage structure for fumigation. Further, prior practices require an increased inventory and additional handling and hazards of pressurized cylinders.

Prior methods and devices for generating phosphine gas using metal phosphide have a number of additional problems. First, any unreacted metal phosphide in the reaction mixture would remain in the commodity after fumigation. This metal phosphide had to be withdrawn in the form of a fine powder or collected in a bag. This handling of the unreacted phosphide metal poses increased health concerns to the operator. Second, the temperature of the reaction pot would increase during the reaction, since the reaction is exothermic. Hence, cooling jackets were needed around the reaction pot which increases the cost of generating the phosphine gas.

In the past, by the way of U.S. Pat. Nos. 7,556,785 and 8,017,090, Applicant disclosed certain improvements in the method of generating fumigant phosphine gas and improvements in the construction of the apparatus that can be used for generating the fumigant phosphine gas, contents of the aforesaid documents are incorporated herein in its entirety.

Thus, it can be observed that the area of producing the fumigant phosphine gas is riddled with a variety of challenges and thus there exists imminent need to provide a system allowing safe, monitored, rapid and continuous generation of phosphine gas.

### OBJECTS OF THE PRESENT INVENTION

It is an object of the present invention to provide a system for generating phosphine gas.

It is another object of the present invention to provide a system allowing safe, monitored, rapid and continuous generation of phosphine gas.

Yet another object of the present invention is to provide a system for generating phosphine gas where any unreacted metal phosphide in the reaction mixture would not remain in the commodity after fumigation.

Yet another object of the present invention is to provide a system for generating phosphine gas such that phosphine gas does not reach to a level above Lower Explosive Limit.

Yet another object of the present invention is to provide a system for generating phosphine gas where commodity is free from any active metal phosphide.

Yet another object of the present invention is to provide a system for generating phosphine gas free of metal phosphide particles.

### SUMMARY OF THE PRESENT INVENTION

An aspect of the present invention is to provide a system for generating phosphine gas, comprising:
a. a reactor including a metal phosphide input;
b. a water reservoir to receive water;
c. an agitation air compressor to supply agitation air to the reactor via a tangential agitation air inlet port;
d. an air blowing unit to provide dilution air;
e. a heater;
f. a control unit to control the operation of heater, agitation air compressor and/or air blowing unit; and
g. a phosphine gas outlet port including a means to prevent the exit of metal phosphide particles from the reactor.

Another aspect of the present invention is to provide a method of generating phosphine gas using the system for generating phosphine gas, comprising the steps of:
a. feeding a metal phosphide and water to the reactor; and
b. mixing therein to form a reaction mixture to generate phosphine gas, wherein the metal phosphide is aluminum phosphide.

### BRIEF DESCRIPTION OF THE ACCOMPANYING DRAWINGS

The features, aspects, and advantages of present invention will become apparent when the following detailed description is read with reference to the accompanying drawings in which like characters represent like parts throughout the drawings, wherein:

FIG. 1 displays a block diagram of a system for generating phosphine gas in accordance with an embodiment of the invention;

FIG. 2 displays a side view of a reactor in accordance with an embodiment of the invention;

FIG. 3 displays the close-up view of the phosphine gas outlet port provided with the means to eliminate the phenomenon of metal phosphide particles from the reactor;

FIG. 4 displays a block diagram of the water reservoir and the associated devices:

FIG. 5 displays the block diagram of the means for withdrawing different predetermined quantities of water from the water reservoir in accordance with an embodiment of the invention; and

FIG. 6 displays a represents the block diagram of the means for withdrawing different predetermined quantities of water from the water reservoir in accordance with another embodiment of the invention.

Further, skilled artisans will appreciate that elements in the drawings are illustrated for simplicity and may not have been necessarily drawn to scale. For example, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein and as being contemplated herein would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The term “Lower Explosive Limit (LEL)” is defined as the minimum percent by volume of a gas which, when mixed with air at normal temperature and pressure, will form an explosive/flammable mixture. At concentrations below the LEL there is not enough fuel to create an explosion. LEL is equivalent to LFL, i.e. Lower Flammable Limit.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the present invention will be described below in detail with reference to the accompanying drawings.

In an embodiment of the present invention there is provided a system for generating phosphine gas.

In an embodiment of the present invention there is provided a system for generating phosphine gas by mixing a metal phosphide and water upon agitation and dilution with air.

In an embodiment, the phosphine gas generated using the system can be used for fumigation purposes and other purposes where phosphine gas is required.

In another embodiment, there is provided a method of generating phosphine gas using the system for generating phosphine gas.

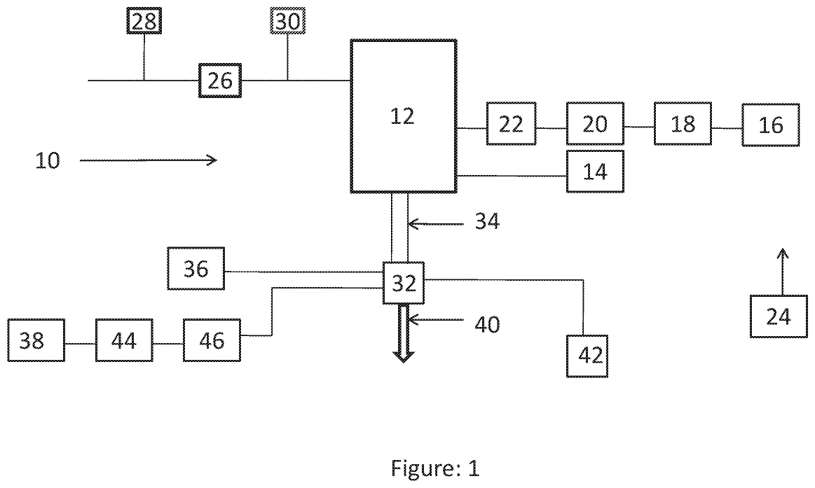

FIG. 1 displays a block diagram of a system (10) for generating phosphine gas. The system (10) comprises a reactor (12) for generating the phosphine gas. A metal phosphide and water are fed to the reactor (12) and mixed therein to form a reaction mixture and to generate phosphine gas. The preferred metal phosphide is aluminum phosphide or other similar phosphides. By way of a non-limiting example, it is possible to generate 1 kg of phosphine gas by mixing 2.2 kg of 77.5% aluminum phosphide with 10 L of water in the reactor (12). In an embodiment of the invention, the reactor (12) is operably coupled to a water reservoir (14) for receiving a necessary quantity of water therefrom.

In an embodiment of the invention, the reactor (12) does not contain any rotating parts like agitators, stirrers, and rotors. This is avoided in the invention to eliminate wear and tear of the agitators, stirrers, and rotors, which will reduce mixing efficiency. Further from the gland/seal there could be leakage of phosphine gas. However, such an arrangement/similar can also be used for stirring the reaction mass. In an embodiment of the invention, to enhance a level of mixing of the water and the metal phosphide, agitation air may be supplied to the reactor (12). Apart from enhancing a level of mixing of the water and the metal phosphide, supply of agitation air may also assist in maintaining a uniform temperature of the reaction mixture. Also, the supply of agitation air may assist in maintaining a temperature of the reaction mixture below a predetermined limit. Further, the agitation air can assist in maintaining a temperature within the reactor below a predetermined limit. Furthermore, the supply of agitation air can assist in maintaining a temperature of the phosphine gas thus generated below a predetermined value. Thus, the reactor (12) is operably coupled to an agitation air compressor (16) for receiving the agitation air therefrom. Preferably, the agitation air fed to the reactor (12) is ambient air under pressure, such that temperature of the phosphine gas generated does not increase beyond 55° C. The agitation air from the agitation air compressor (16) is preferably supplied at a turbulating pressure of 0.5 to 2 kg/cm².

In an embodiment of the invention, the agitation air compressor (16) is connected to the reactor (12) in a manner such that any unwanted disruption in the supply of agitation air to the reactor (12) can be detected. In particular, in an air path between the agitation air compressor (16) and the reactor (12), a pressure transducer (18), a flow meter (20) and an air flow controlling valve (22) are provided. The pressure transducer (18) and the flow meter (20) are coupled to a control unit (24). The control unit (24) can detect whether the agitation air compressor (16) is working sufficiently on basis of the output as provided by the pressure transducer (18) and the flow meter (20). The control unit (24) can furthermore localize error if any. By way of example, if the pressure transducer (18) is providing output at a level within a first pre-set range and the flow meter (20) is providing output at a level within a second pre-set range, the control unit (24) can detect that the air path between the agitation air compressor (16) and the reactor (12) is not having any blockage and that agitation air compressor (16) is working sufficiently. By way of example, if the pressure transducer (18) is providing output at a level above the first pre-set range and the output of the flow meter (20) is below the second pre-set range, the control unit (24) can detect that the air path between the agitation air compressor (16) and the reactor is having some blockage. By way of example, if the pressure transducer (18) is providing an output at a level below the first pre-set range and the output of the flow meter (20) is below the second pre-set range, the control unit (24) can detect that agitation air compressor (16) is not working sufficiently.

In an embodiment, the control unit (24) can be adapted to control the operation of agitation air compressor (16) so as to meet with the requirement of the agitation air in the reactor (12).

In case there is a blockage in the air path between the agitation air compressor (16) and the reactor (12) as indicated by the output of the pressure transducer (18) and the output of the flow meter (20) (as mentioned above), the agitation air compressor (16) can be switched OFF (by the control unit (24)) so that no further damage is caused to the system (10).

Since the phosphine gas is explosive in nature, preventive measures will have to be taken such that a concentration of phosphine gas within the reactor (12) does not reach to a level above Lower Explosive Limit. In an embodiment of the invention, the reactor (12) will be supplied with dilution air to maintain a concentration of phosphine gas within the reactor (12) at a level below the Lower Explosive Limit. Thus, in accordance with an embodiment, the reactor (12) is operably coupled to an air blowing unit (26) for receiving the dilution air therefrom.

In an embodiment of the invention, the air blowing unit (26) is connected to the reactor (12) in a manner such that any unwanted disruption in the supply of dilution air to the reactor (12) can be detected. In particular, on an inlet side of the air blowing unit (26) an inlet pressure transducer (28) is coupled and an outlet pressure transducer (30) is coupled to on an outlet side of the air blowing unit (26). The inlet pressure transducer (28) and outlet pressure transducer (30) are connected to the control unit (24). The control unit (24) is further adapted to detect whether the air blowing unit (26) is working sufficiently on basis of the outputs as provided by the inlet pressure transducer (28) and outlet pressure transducer (30). By way of example, if the inlet pressure transducer (28) is providing an output at a level within a third pre-set range, it can be said that the air blowing unit (26) is withdrawing air and that there is no blockage on the inlet end of the air blowing unit (26). By way of another non-limiting example, if the outlet pressure transducer (30) is providing output at a level within a fourth pre-set range, it can be said that the air blowing unit (26) is dispensing air and that there is no blockage on the outlet end of the air blowing unit (26). By way of a further non-limiting example, if the inlet pressure transducer (28) is providing output at a level above the third pre-set range, it can be said that the air blowing unit (26) is attempting to withdraw air but there is a blockage on the inlet end of the air blowing unit (26). By way of a furthermore non-limiting example, if the inlet pressure transducer (28) is providing output at a level below the first pre-set range and the outlet pressure transducer (30) is providing output at a level below the second pre-set range, it can be said that the air blowing unit (26) is not functioning. By way of a further non-limiting example, if the outlet inlet pressure transducer (30) is providing output at a level above the second pre-set range, it can be said that the air blowing unit (26) is dispensing air but there is blockage on the outlet end of the air blowing unit (26). Thus, the control unit (24) can localize the error, if any.

In case the air blowing unit (26) is functioning sufficiently but the requirement of the dilution air in the reactor (12) changes (i.e. increases or decreases), the control unit (24) can be adapted to control the operation of air blowing unit (26) so as to meet with the requirement of the dilution air in the reactor (12).

Any unused reaction mixture as may be present in the reactor (12) may be directed to a secondary reactor (32) for deactivation. The unused reaction mixture remaining in the reactor (12) is preferably discharged via an unused reaction mixture line (34) to the secondary reactor (32). The secondary reactor (32) may also be connected to a gas blowing unit (36) which provides air and unreacted fumigant phosphine gas to the secondary reactor (32). In the secondary reactor (32), the unused reaction mixture and the unreacted fumigant phosphine gas are deactivated using sparger air and/or a supply of cleaning water. Thus, the secondary reactor (32) may be connected to sparger air compressor (38) which supplies sparger air to the secondary reactor (32). The secondary reactor (32) may be connected to the water reservoir (14) for receiving the supply of cleaning water therefrom.

The secondary reactor (32) produces a drainable residue at a residue outlet (40) that is free from any active metal phosphide. The phosphine gas remaining in the secondary reactor (32) is fed to an absorption tank (42). The secondary reactor (32) and the absorption tank (42) provide an environmentally friendly means to clean the unused reaction mixture and phosphine gas after the commodity is fumigated. In a preferred embodiment, the deactivation process takes about 180 minutes. It should be understood that one of ordinary skill in the art may utilize other similar means for removing and/or cleaning the unused reaction mixture and phosphine gas from the system.

In an embodiment of the invention, the sparger air compressor (38) is connected to the secondary reactor (32) in a manner such that any unwanted disruption in the supply of sparger air to the secondary reactor (32) can be detected.

In particular, in an air path between the sparger air compressor (38) and the secondary reactor (32), a pressure transducer (44) and a flow meter (46) is provided. The pressure transducer (44) and the flow meter (46) are coupled to the control unit (24).

The control unit (24) is adapted to detect whether the sparger air compressor (38) is working sufficiently on basis of the output as provided by the pressure transducer (44) and the flow meter (46). The control unit (24) can furthermore localize error if any. By way of example, if the pressure transducer (44) is providing output at a level within a fifth pre-set range and the flow meter (46) is providing output at a level within a sixth pre-set range, the control unit (24) can detect that the air path between the sparger air compressor (38) and the secondary reactor (32) is not having any blockage and that sparger air compressor (38) is working properly. By way of example, if the pressure transducer (44) is providing output at a level above the fifth pre-set range and the output of the flow meter (46) is below the sixth pre-set range, the control unit (24) can detect that the air path between the sparger air compressor (38) and the secondary reactor (32) is having some blockage. By way of example, if the pressure transducer (44) is providing an output at a level below the fifth pre-set range and the output of the flow meter (46) is below the sixth pre-set range, the control unit (24) can detect that sparger air compressor (38) is not working sufficiently.

The control unit (24) can be adapted to control the operation of sparger air compressor (38) so as to meet with the requirement of the sparger air in the secondary reactor (32).

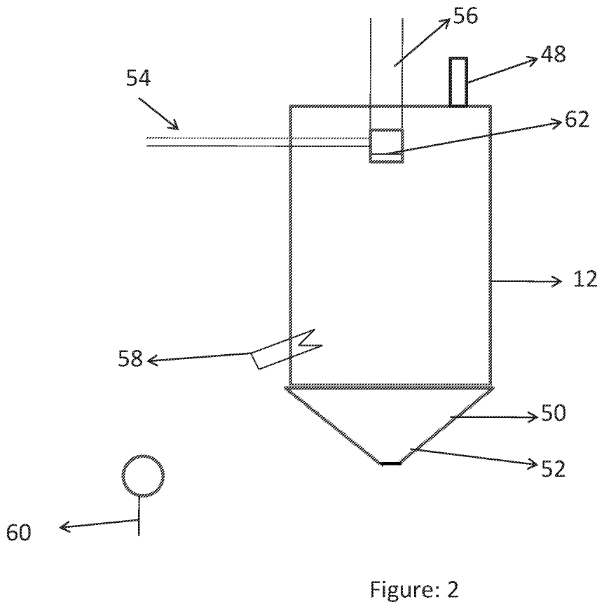

Now referring FIG. 2, which is a side view of the reactor (12), the construction of the reactor (12) will be explained in greater detail. The reactor (12) includes a metal phosphide input (48) for receiving the supply of the metal phosphide. In a preferred embodiment, the water enters the reactor (12) via a tangential water inlet port (50). By providing the tangential water inlet port (52), it is possible to reduce splashing of metal phosphide on the side walls of the reactor. The tangential water inlet port (50) also ensures that water is not carried away due to air circulation inside the reactor (12). Carrying away of water by air circulating in the reactor can lead to reduced water availability for the reaction with the metal phosphide, which could lead to increase in temperature during the reaction, which in turn could lead to fire/explosion/high temperature during the reaction.

In a preferred embodiment, a bottom portion of the reactor (12) is of conical shape and a agitation air enters the reactor (12) via a tangential agitation air inlet port (52). In a preferred embodiment, the dilution air enters the reactor (12) via a dilution air inlet port (54). The phosphine gas formed in the reactor (12) is withdrawn from a phosphine gas outlet port (56). In an embodiment, the dilution air inlet port (54) terminates close to the phosphine gas outlet port (56). In an embodiment of the invention, the reactor (12) is provided with a heater (58). The control unit (24) is configured to operate the heater (58) so as to heat the reaction mixture contained in the reactor (12) whenever required. In an embodiment of the invention, the control unit (24) may receive ambient temperature from a temperature sensor (60) and control the operation of the heater (58). By way of a non-limiting example, if the ambient temperature goes below 25° C., the reaction occurring within the reactor (12) may become slow and thus, phosphine gas generation time will increase. This can be readily fixed by the control unit (24) by operating the heater (58).

In some cases, the metal phosphide particles as contained in the reactor may rise and may exit the reactor (12) via the phosphine gas outlet port (56). Such exit of metal phosphide particles is not desired as the metal phosphide particles can get accumulated at any point in the phosphine gas outlet port (56) or in any part of the system (10), that can lead to flashing. In case the metal phosphide particles are carried away with the generated gas, it can lead to contamination of the fumigating commodity.

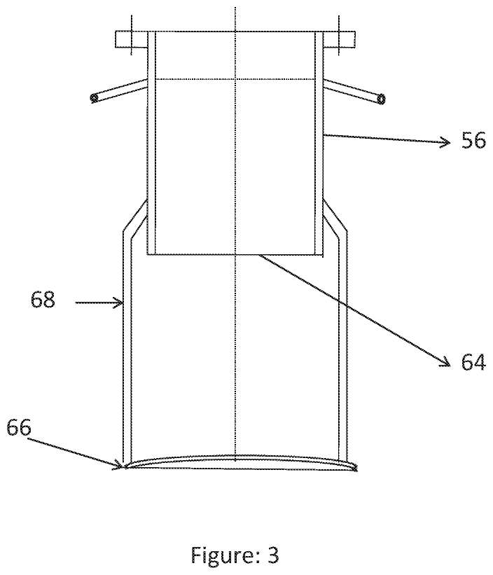

To prevent the exit of metal phosphide particles from the inner volume of the reactor, the phosphine gas outlet port (56) is provided with a means (62) as illustrated in FIG. 3.

Now referring to FIG. 3, there is illustrated a close-up view of the phosphine gas outlet port (56). The phosphine gas outlet port (56) is defined by an outlet pipe (64) protruding inside the reactor (12). A barrier (66) is attached at about an inlet end of the outlet pipe (64) and acts as the means (62) for reducing the exit of metal phosphide from the reactor (12). The obstruction (62) is attached to about the inlet end of the outlet pipe (64) via a set of barriers supporting elements (68). In an embodiment of the invention, barrier (66) is configured in the form of a dish preferably curved having its concave surface facing the inner bottom surface of the reactor. The dish (68) may preferably be of a curve shape. In an embodiment, a diameter of the dish (68) is 1.2 to 3.0 times the diameter of the outlet pipe (64).

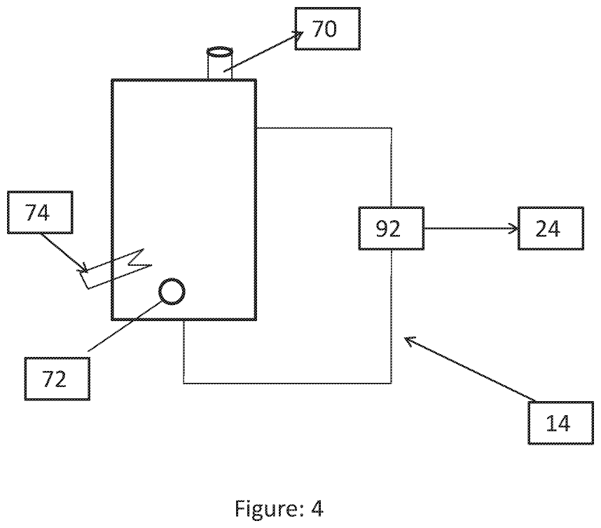

Now referring to FIG. 4, there is a detailed view of the water reservoir (14), and associated devices. The water reservoir (14) may be coupled to the agitation air compressor (16) for receiving pressurized air therefrom. Using the pressurized air, the water contained in the water reservoir (14) can be transported to the reactor (12) or to the secondary reactor (32). The water reservoir (14) comprises air input port (70) for receiving the pressurized air from the agitation air compressor (16). A temperature sensor (72) and a heater (74) is provided within the water reservoir (14) for heating the water contained therein. The water reservoir (14) is further provided with a means for withdrawing different predetermined quantities of water therefrom such that the predetermined quantities of water may be transported to at least one water consumption unit as provided in the system (10).

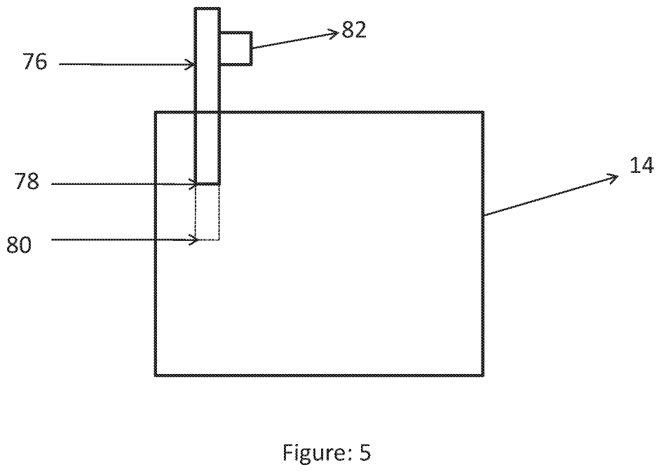

Referring now particularly to FIG. 5, in an embodiment of the invention, the water reservoir (14) comprises a water withdrawal conduit (76) provided within the water reservoir. The water withdrawal conduit (76) is adapted to be located at a first predetermined location (78) and a second predetermined location (80). In an embodiment, the first predetermined location (78) corresponds to a first predetermined volume of water, and the second predetermined location (80) corresponds to a second predetermined volume of water. The water withdrawal conduit (76) is connected via a first fluid transportation path to the reactor (12). The water withdrawal conduit (72) is connected via a second fluid transportation path to the secondary reactor (32). The first predetermined volume of water may thus be transported to the reactor (12) while the second predetermined volume of water may be transported to the secondary reactor (32).

The water withdrawal conduit (76) may be operably connected to at least one mechanical drive system (82) for adjusting the vertical height of the water withdrawal conduit (76) inside the water reservoir (12).

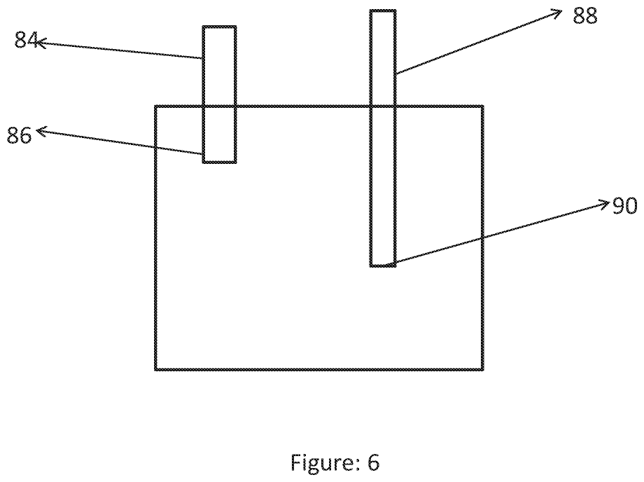

Referring now to FIG. 6, in an embodiment of the invention, the water reservoir (14) comprises a first water withdrawal conduit (84) provided within the water reservoir, the first water withdrawal conduit adapted to be located at a first predetermined location (86), the first predetermined location (86) corresponding to a first predetermined volume of water. The water reservoir (14) further comprises a second water withdrawal conduit (88) provided within the water reservoir (14), the second water withdrawal conduit (88) adapted to be located at a second predetermined location (90), the second predetermined location (90) corresponding to a second predetermined volume of water. The first and the second water withdrawal conduits (84, 88) are connected to at least one fluid transportation path connecting the first and the second water withdrawal conduits to the at least one water consumption unit for supplying the first predetermined volume of water and the second predetermined volume of water thereto.

Referring back to FIG. 4, to ensure that necessary quantity of water is present in the water reservoir and that only the predetermined quantity of water is withdrawn from the water reservoir (14), a differential pressure transmitter (92) is provided which measures the level of water in the water reservoir (14). The differential pressure transmitter (92) may be coupled to the control unit (24) for providing an output signal thereto. Based on the output received from the differential pressure transmitter (92), the control unit may add water to the water reservoir (14) or control other operating parameters in the system (10).

In an embodiment, a method of generating phosphine gas using the system for generating phosphine gas comprising the steps of:
feeding a metal phosphide and water to the reactor; and
mixing therein to form a reaction mixture to generate phosphine gas.

In an embodiment, the preferred metal phosphide is aluminum phosphide or other similar phosphides. By way of a non-limiting example, it is possible to generate 1 kg of phosphine gas by mixing 2.2 kg of 77.5% aluminum phosphide with 10 L of water in the reactor (12).

In a preferred embodiment, the water enters the reactor via a tangential water inlet port to reduce splashing of metal phosphide on the side walls of the reactor. The tangential water inlet port also ensures that water is not carried away due to air circulation inside the reactor.

In an embodiment, the method of generating phosphine gas using the system to generate phosphine gas further comprises the steps of:
supplying agitation air to the reactor, preferably ambient air under pressure such that temperature of the phosphine gas generated does not increase beyond 55° C.,
supplying dilution air to maintain a concentration of phosphine gas within the reactor at a level below the Lower Explosive Limit,
discharging unused reaction mixture remaining in the reactor preferably via an unused reaction mixture line to a secondary reactor,
supplying sparger air and/or cleaning water to the secondary reactor to produce a drainable residue at a residue outlet that is free from any active metal phosphide, and
feeding the phosphine gas remaining in the secondary reactor to an absorption tank to clean the unused reaction mixture and phosphine gas after commodity is fumigated.

In an embodiment, the method of generating phosphine gas using the system to generate phosphine gas further comprises the step of heating the reaction mixture contained in the reactor whenever required.

While certain present preferred embodiments of the invention have been illustrated and described herein, it is to be understood that the invention is not limited thereto. Clearly, the invention may be otherwise variously embodied, and practiced within the scope of the aforesaid description.

### REFERRAL NUMERAL

| Referral numeral | Description |
|---|---|
| 10 | System |
| 12 | Reactor |
| 14 | Reservoir |
| 16 | Compressor |
| 18 | Transducer |
| 20 | Flow meter |
| 22 | Controlling valve |
| 24 | Control unit |
| 26 | Blowing unit |
| 28 | Inlet pressure transducer |
| 30 | Outlet pressure transducer |
| 32 | Secondary reactor |
| 34 | Unused reaction mixture line |
| 36 | Gas blowing unit |
| 38 | Sparger air compressor |
| 40 | Residue outlet |
| 42 | Absorption tank |
| 44 | Pressure transducer |
| 46 | Flow meter |
| 48 | Metal phosphide input |
| 50 | Tangential water inlet port |
| 52 | Tangential agitation air inlet port |
| 54 | Dilution air inlet port |
| 56 | Phosphine gas outlet port |
| 58 | Heater |
| 60 | Temperature sensor |
| 62 | Means |
| 64 | Outlet pipe |
| 66 | Barrier |
| 68 | Dish |
| 70 | Inlet port |
| 72 | Temperature sensor |
| 74 | Heater |
| 76 | Conduit |
| 78 | First predetermined location |
| 80 | Second predetermined location |
| 82 | Mechanical drive system |
| 84 | First water withdrawal conduit |
| 86 | First predetermined location |
| 88 | Second water withdrawal conduit |
| 90 | Second predetermined location |
| 92 | Differential pressure transmitter |

1. A system for generating phosphine gas, comprising:
a. a reactor including a metal phosphide input;
b. a water reservoir to receive water;
c. an agitation air compressor to supply agitation air to the reactor via a tangential agitation air inlet port;
d. an air blowing unit to provide dilution air;
e. a heater;
f. a control unit to control the operation of heater, agitation air compressor and/or air blowing unit; and
g. a phosphine gas outlet port including a means to prevent the exit of metal phosphide particles from the reactor.

2. The system as claimed in claim 1, wherein the control unit receives ambient temperature from a temperature sensor and control the operation of the heater.

3. The system as claimed in claim 1, wherein the agitation air compressor is connected to the reactor in a manner such that unwanted disruption in supply of agitation air to the reactor can be detected.

4. The system as claimed in claim 1, wherein the air blowing unit is connected to the reactor in a manner such that unwanted disruption in supply of dilution air to the reactor can be detected.

5. The system as claimed in claim 1, wherein the air blowing unit comprises an inlet pressure transducer and an outlet pressure transducer, wherein said inlet pressure transducer and outlet pressure transducer are connected to the control unit.

6. The system as claimed in claim 1, further comprises, in air path between the agitation air compressor and the reactor,
h. a pressure transducer;
i. a flow meter; and
j. an air flow controlling valve.

7. The system as claimed in claim 6, wherein the pressure transducer and the flow meter are coupled to the control unit.

8. The system as claimed in claim 1, further comprises a secondary reactor for deactivating unused reaction mixture and/or unreacted fumigant phosphine gas in the reactor.

9. The system as claimed in claim 7, wherein the secondary reactor comprises a sparger air compressor to supply sparger air to the secondary reactor, a water reservoir to supply cleaning water and a control unit, and wherein the secondary reactor produces a drainable residue at a residue outlet that is free from any active metal phosphide.

10. A method of generating phosphine gas using the system for generating phosphine gas, comprising the steps of:
k. feeding a metal phosphide and water to the reactor; and
l. mixing therein to form a reaction mixture to generate phosphine gas,
wherein the metal phosphide is aluminum phosphide.

11. The system as claimed in claim 4, wherein the air blowing unit comprises an inlet pressure transducer and an outlet pressure transducer, wherein said inlet pressure transducer and outlet pressure transducer are connected to the control unit.

12. The system as claimed in claim 2, further comprises a secondary reactor for deactivating unused reaction mixture and/or unreacted fumigant phosphine gas in the reactor.

13. The system as claimed in claim 3, further comprises a secondary reactor for deactivating unused reaction mixture and/or unreacted fumigant phosphine gas in the reactor.

14. The system as claimed in claim 4, further comprises a secondary reactor for deactivating unused reaction mixture and/or unreacted fumigant phosphine gas in the reactor.

15. The system as claimed in claim 5, further comprises a secondary reactor for deactivating unused reaction mixture and/or unreacted fumigant phosphine gas in the reactor.

16. The system as claimed in claim 6, further comprises a secondary reactor for deactivating unused reaction mixture and/or unreacted fumigant phosphine gas in the reactor.

17. The system as claimed in claim 7, further comprises a secondary reactor for deactivating unused reaction mixture and/or unreacted fumigant phosphine gas in the reactor.

18. The system as claimed in claim 11, further comprises a secondary reactor for deactivating unused reaction mixture and/or unreacted fumigant phosphine gas in the reactor.
